(19) United States
(12) Patent Application Publication
(10) Pub. No.: US 2017/0210173 A1
(43) Pub. Date: Jul. 27, 2017

(54) CROWN REINFORCEMENT FOR AN AIRCRAFT

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventors: Emmanuel JOULIN, Clermont-Ferrand Cedex 9 (FR); Vincent ESTENNE, Clermont-Ferrand Cedex 9 (FR)

(21) Appl. No.: 15/329,771

(22) PCT Filed: Jul. 8, 2015
(86) PCT No.: PCT/EP2015/065590

§ 371 Date: Jan. 27, 2017

(30) Foreign Application Priority Data
Jul. 30, 2014 (FR) 1457378

(51) Int. Cl. B60C 9/28; B60C 9/00

(52) U.S. Cl. CPC B60C 9/28; B60C 9/0042; B60C 2009/2223

(57) ABSTRACT

Tire for an aeroplane and, in particular, the crown thereof which comprises a tread (1), a working reinforcement (2), a carcass reinforcement (3) and a hoop reinforcement (4). The radially internal working layer (21) of the working reinforcement (2) comprises a concave portion. The hoop reinforcement (41) comprises at least one hooping layer (41) radially on the inside of the working layer (21) and made up of mutually parallel reinforcing elements, having a mean diameter D, that are inclined, with respect to the circumferential direction (XX′), at an angle of between +10° and −10°. The hooping layer (41) comprises at least one axial discontinuity (411) having an axial width (L411) at least equal to three times the mean diameter D of the reinforcing elements of the hooping layer (41).

The present invention relates to a tire for an aeroplane and, in particular, to the crown of an aeroplane tire.

A tire comprises a crown comprising a tread that is intended to come into contact with the ground via a tread surface, two beads that are intended to come into contact with a rim, and two sidewalls that connect the crown to the beads. A radial tire, as generally used for an aeroplane, more particularly comprises a radial carcass reinforcement and a crown reinforcement, as described, for example, in document EP1 381 525.

Since a tire has a geometry that exhibits symmetry of revolution about an axis of rotation, the geometry of the tire is generally described in a meridian plane containing the axis of rotation of the tire. For a given meridian plane, the radial, axial and circumferential directions denote the directions perpendicular to the axis of rotation of the tire, parallel to the axis of rotation of the tire and perpendicular to the meridian plane, respectively.

In the following text, the expressions “radially on the inside of” and “radially on the outside of” mean “closer to the axis of rotation of the tire, in the radial direction, than” and “further away from the axis of rotation of the tire, in the radial direction, than”, respectively. The expressions “axially on the inside of” and “axially on the outside of” mean “closer to the equatorial plane, in the axial direction, than” and “further away from the equatorial plane, in the axial direction, than”, respectively. A “radial distance” is a distance with respect to the axis of rotation of the tire and an “axial distance” is a distance with respect to the equatorial plane of the tire. A “radial thickness” is measured in the radial direction and an “axial width” is measured in the axial direction.

The radial carcass reinforcement is the tire reinforcing structure that connects the two beads of the tire. The radial carcass reinforcement of an aeroplane tire generally comprises at least one carcass reinforcement layer referred to as the carcass layer. Each carcass layer consists of reinforcing elements which are coated in a polymeric material, are parallel to one another and form an angle of between 80° and 100° with the circumferential direction. Each carcass layer is unitary, i.e. it comprises only one reinforcing element in its thickness.

The crown reinforcement is the reinforcing structure of the tire radially on the inside of the tread and usually radially on the outside of the radial carcass reinforcement. The crown reinforcement of an aeroplane tire generally comprises at least one crown reinforcement layer referred to as the crown layer. Each crown layer consists of reinforcing elements which are coated in a polymeric material, are parallel to one another and form an angle of between +20° and −20° with the circumferential direction. Each crown layer is unitary, i.e. it comprises only one reinforcing element in its thickness.

Among the crown layers, a distinction is made between the working layers that constitute the working reinforcement and are usually made up of textile reinforcing elements, and the protective layers that constitute the protective reinforcement, are made up of metal or textile reinforcing elements and are arranged radially on the outside of the working reinforcement. The working layers govern the mechanical behaviour of the crown. The protective layers essentially protect the working layers from attack likely to spread through the tread radially towards the inside of the tire. A crown layer, in particular a working layer, is often an axially wide layer, i.e. one that has an axial width, for example, at least equal to two-thirds of the maximum axial width of the tire. The maximum axial width of the tire is measured at the sidewalls, the tire being mounted on its rim and lightly inflated, i.e. inflated to a pressure equal to 10% of the nominal pressure as recommended, for example, by the Tire and Rim Association or TRA.

The tire can also comprise a hoop reinforcement radially on the inside or radially on the outside of the crown reinforcement or interposed between two crown layers. The hoop reinforcement of an aeroplane tire generally comprises at least one hoop reinforcement layer referred to as the hooping layer. Each hooping layer consists of reinforcing elements which are coated in a polymeric material, are parallel to one another and form an angle of between +10° and −10° with the circumferential direction. A hooping layer is usually an axially narrow working layer, i.e. one that has an axial width substantially less than the axial width of a crown layer and, for example, at most equal to 80% of the maximum axial width of the tire. The axial width is understood to be the axial distance between the axially outermost reinforcing elements of the hooping layer, whether or not the distance between each reinforcing element is constant in the axial direction.

The reinforcing elements of the carcass, working and hooping layers, for aeroplane tires, are usually cords made up of spun textile filaments, preferably made of aliphatic polyamides or aromatic polyamides. The reinforcing elements of the protective layers may be either cords made up of metal threads or cords made up of spun textile filaments. The axial distance between the centres of two consecutive reinforcing elements in a layer is known as the reinforcement pitch. For the crown and hoop reinforcements, this pitch is usually constant in the axial direction.

As far as the textile reinforcing elements are concerned, the mechanical properties under tension (modulus, elongation and breaking force) of the textile reinforcing elements are measured after prior conditioning. “Prior conditioning” means the storage of the textile reinforcing elements for at least 24 hours, prior to measurement, in a standard atmosphere in accordance with European Standard DIN EN 20139 (temperature of 20+/−2° C.; relative humidity of 65+/−2%). The measurements are taken in the known way using a ZWICK GmbH & Co (Germany) tensile test machine of type 1435 or type 1445. The textile reinforcing elements are subjected to tension over an initial length of 400 mm at a nominal rate of 200 mm/min. All the results are means of 10 measurements.

Aeroplane tires often exhibit non-uniform wear to the tread, known as irregular wear, resulting from the stresses that occur during the various life stages of the tire: take-off, taxiing and landing. Differential wear to the tread between a middle part and the two lateral parts of the tread, axially on the outside of the middle part, has more particularly been observed. Usually, it is desirable for the wear to the middle part to be greater and to control the life of the tire. In some cases, the abovementioned differential wear worsens the wear to the lateral parts of the tread, this becoming predominant with respect to the wear to the middle part, resulting in economically disadvantageous premature removal of the tire.

A person skilled in the art is familiar with the fact that the wear to the tread of a tire depends on several factors associated with the use and design of the tire. Wear depends in particular on the geometric shape of the contact patch via which the tread of the tire makes contact with the ground and on the distribution of mechanical stresses in this contact patch. These two parameters depend on the inflated meridian profile of the tread surface. The inflated meridian profile of the tread surface is the cross section through the tread surface, on a meridian plane, for an unladen tire inflated to its nominal pressure.

In order to increase the life of the tire with regard to the differential wear to the middle part of the tread, a person skilled the art has sought to optimize the geometric shape of the inflated meridian profile of the tread surface.

The document EP 1 163 120 discloses a crown reinforcement of an aeroplane tire, wherein attempts have been made to limit the radial deformations when the tire is being inflated to its nominal pressure, thereby making it possible to limit the radial deformations of the inflated meridian profile of the tread surface. The radial deformations of the crown reinforcement when the tire is being inflated to its nominal pressure is successfully limited by increasing the circumferential tensile stiffnesses of the crown layers, this being obtained by replacing the crown layer reinforcing elements, which are usually made of aliphatic polyamides, with reinforcing elements made of aromatic polyamides. Because the moduli of elasticity of reinforcing elements made of aromatic polyamides are higher than those of reinforcing elements made of aliphatic polyamides, the elongations of the former, for a given tensile loading, are smaller than those of the latter.

The document EP 1 381 525 cited above proposes one approach which is to alter the geometric shape of the inflated meridian profile of the tread surface by altering the tensile stiffnesses of the crown and/or carcass layers. That document proposes the use of hybrid reinforcing elements, that is to say reinforcing elements made both of aliphatic polyamides and of aromatic polyamides, rather than the usual reinforcing elements made of aliphatic polyamides. These hybrid reinforcing elements have moduli of elasticity that are higher than those of the reinforcing elements made of aliphatic polyamides, and therefore have lower elongations, for a given tensile loading. The hybrid reinforcing elements are used in the crown layers to increase the circumferential tensile stiffnesses and/or in the carcass layers to increase the tensile stiffnesses in the meridian plane.

The document EP 1 477 333 proposes another approach which is to alter the geometric shape of the inflated meridian profile of the tread surface by axially altering the overall circumferential tensile stiffness of the crown reinforcement in such a way that the ratio between the overall circumferential tensile stiffnesses of the axially outermost parts of the crown reinforcement and of the middle part of the crown reinforcement lies within a defined range. The overall circumferential tensile stiffness of the crown reinforcement is a result of the combination of the circumferential tensile stiffnesses of the crown layers. The overall circumferential tensile stiffness of the crown reinforcement varies in the axial direction according to changes in the number of superposed crown layers. The proposed solution is based on an axial distribution of the overall circumferential tensile stiffnesses between the middle part and the axially outermost parts of the crown reinforcement, the middle part being stiffer than the axially outermost parts of the crown reinforcement. The reinforcing elements used in the crown or carcass layers are made of aliphatic polyamides, aromatic polyamides or are hybrid.

The document WO 2010000747 describes an aeroplane tire, the nominal pressure of which is higher than 9 bar and the deflection of which under nominal load is greater than 30%, comprising a tread having a tread surface, a crown reinforcement, comprising at least one crown layer, a carcass reinforcement comprising at least one carcass layer, said tread surface, crown reinforcement and carcass reinforcement respectively being geometrically defined by initial meridian profiles. According to the invention, the initial meridian profile of the crown reinforcement is locally concave over a middle part having an axial width at least equal to 0.25 times the axial width of the crown reinforcement. The technical solution described in the document WO 2010000747 allows an increase in the wear life of an aeroplane tire by limiting the differential wear to the tread between a middle part and the lateral parts axially on the outside of this middle part.

While the tire lasts longer on account of more even wear across the width of the tread, its endurance performance needs to be ensured throughout its longer life by virtue of this better wear pattern. In particular, the endurance of the crown of the tire, i.e. its ability to withstand, over time, the heavy mechanical demands placed on the tire, needs to be improved. Heavy mechanical demands means, for example and in a non-limiting manner, a nominal pressure in excess of 15 bar, a nominal load in excess of 20 tonnes and a maximum speed of 360 km/h in the case of a commercial airliner tire.

The document WO 2013079351A1 proposes an improvement to the solution described in the document WO 2010000747 using an initial meridian profile of the crown reinforcement that is locally concave. This improvement consists in optimizing the geometry of the radial carcass reinforcement and of the working reinforcement through the choice of a distance between the radially outermost carcass layer and the radially innermost working layer that decreases continuously from the equatorial plane.

The change from a conventional meridian profile of the carcass reinforcement and working reinforcement, respectively, as described in the document EP 1 381 525, to a concave profile as described in the document WO2013079351A1 causes a significant increase in tension in the reinforcing elements of the working layers; of around +15% at the equatorial plane for one and the same radial stack of carcass layers and working layers and one and the same mean radius of the radially external meridian profile of the tread. The burst pressure of the tire decreases by as much with all other elements remaining the same; this can compromise the certification of the tire by regulatory tests in order to be marketed. Furthermore, the use of hooping with constant pitch across the width of the hooping layer, as suggested by the continuous decrease in the distance between the radially outermost carcass layer and the radially innermost crown layer from the equatorial plane to the axial limits of the concave portions, is not optimal from the point of view of the weight of the tire and thus of its cost.

The inventors have set themselves the objective of improving the endurance of the working reinforcement of a tire for an aeroplane, when its life is increased with regard to the wear to the tread, while decreasing the industrial manufacturing cost by reducing the weight of the tire.

This objective has been achieved by a tire for an aeroplane, comprising:
a tread,
a working reinforcement radially on the inside of the tread and comprising at least one working layer,
the radially internal working layer having an axial width at least equal to two-thirds of the maximum axial width of the tire and comprising a concave middle portion,
a carcass reinforcement radially on the inside of the working reinforcement and comprising at least one carcass layer,
a hoop reinforcement radially on the outside of the carcass reinforcement and comprising at least one hooping layer,
the hooping layer having an axial width at most equal to 0.8 times the width of the widest working layer and comprising mutually parallel reinforcing elements that are inclined, with respect to the circumferential direction, at an angle of between +10° and −10 °,
the reinforcing elements of the hooping layer having a mean diameter D,
the hooping layer comprising at least one axial discontinuity having an axial width at least equal to three times the mean diameter D of the reinforcing elements.

The working reinforcement of a tire is generally made up of a plurality of radially superposed working layers that have, in a meridian plane of the tire, axial widths that are generally different from one layer to another, in order to stagger the axial ends of said crown layers. The working reinforcement generally comprises at least one working layer referred to as wide, i.e. with an axial width at least equal to two-thirds of the maximum axial width of the tire. The maximum axial width of the tire is measured at the sidewalls, with the tire mounted on its rim and lightly inflated, i.e. inflated to a pressure equal to 10% of the recommended nominal pressure. Usually, but not exclusively, the radially internal working layer, i.e. the one that is radially innermost, is the widest working layer.

The axial width of a working layer is the axial distance between the end points of the working layer. It is usually measured on a meridian section of the tire, obtained by cutting the tire on two meridian planes. By way of example, a meridian section of tire has a thickness in the circumferential direction of around 60 mm at the tread. The measurement is taken with the distance between the two beads being kept identical to that of the tire mounted on its rim and lightly inflated.

Furthermore, the radially internal working layer comprises a concave portion, the axial limits of which, on either side of the equatorial plane, are the radially external points of said crown layer. These axial limits are generally substantially equidistant from the equatorial plane, i.e. substantially symmetrical about the equatorial plane, give or take the manufacturing tolerances, but different distances on either side of the equatorial plane are not excluded. A wide working layer is needed in order to have a concave portion of significant axial width.

A concave portion, in the meridian plane, comprises a radially internal point in the equatorial plane and two radially external points, one on either side of the equatorial plane, which are the axial limits of the concave portion. All of the points of the concave portion are therefore radially on the outside of the point positioned in the equatorial plane and radially on the inside of the points that are the axial limits of the concave portion.

A concave portion within the meaning of the invention is not a concave portion in the mathematical sense of the term. Specifically, it comprises a central part that is concave in the mathematical sense with, at every point on said concave central part, a centre of curvature radially on the outside of said concave central portion and, on either side of the concave central part, a lateral part that is convex in the mathematical sense with, at every point of said convex lateral part, a centre of curvature that is radially on the inside of said convex lateral portion. The concave central part is axially delimited by two points of inflection, one on either side of the equatorial plane. Each convex lateral part is delimited axially on the inside by a point of inflection and axially on the outside by an axial limit of the concave portion.

The other working layers, radially on the outside of the internal working layer, often comprise a concave portion of axial width substantially equal to that of the concave portion of the radially internal working layer. This happens in particular when the working layers are adjacent in pairs and are not separated by interlayered elements, for example made of elastomeric material. The respective meridian profiles of said working layers are then parallel in pairs, i.e. equidistant over their entire respective axial widths.

In order to limit the increase in stresses in the working layers, a hoop reinforcement made up of at least one hooping layer is fitted between the radially outermost carcass layer and the radially innermost working layer. Such a hoop reinforcement positioned in the middle zone has the function of limiting radial movements of the working reinforcement in the middle zone while the tire is being inflated, and of thus obtaining a tread profile that is more or less flat over the entire axial width of the tread surface. It also makes it possible to limit excess tension in the working layers at the equatorial plane.

The configuration of the hooping layer allowing the best compromise with regard to the endurance and raw material cost is surprisingly not a continuous hooping layer disposed over the smallest possible width but a discontinuous hooping layer comprising at least one axial discontinuity, thereby also making it possible to reduce the weight of said hooping layer.

Axial discontinuity means a local increase in pitch between two consecutive reinforcing elements. This axial discontinuity is characterized by its axial width, i.e. by the axial distance between the reinforcing elements delimiting said axial discontinuity. According to the invention, the hooping layer comprises at least one such axial discontinuity having an axial width with a minimum value equal to three times the mean diameter D of the reinforcing elements. Specifically, disposing the reinforcing elements of the hooping layer in a discontinuous manner in the axial direction makes it possible to optimize the distribution of stresses in the working reinforcement layer at the shoulders or at the centre of the tire. In addition, each of these discontinuities having a width at least equal to three times the mean diameter D of the reinforcing elements reduces the number of reinforcing elements in the hooping layer and thus the cost of the hooping layer.

It is particularly advantageous for the axial width of the axial discontinuity to be at least equal to 10 times the mean diameter D of the reinforcing elements of the hooping layer, since this reduces the number of reinforcing elements in the hooping layer and allows savings in the industrial manufacturing cost.

It is also advantageous for the hooping layer to comprise at least two axial discontinuities having an axial width at least equal to three times the mean diameter D of the reinforcing elements. Specifically, this makes it possible to optimally distribute the reinforcing elements of the hooping layer in such a way as to optimize the tensions in the reinforcing elements of the working layers.

It is also advantageous for one axial discontinuity to be centered on the equatorial plane of the tire. Specifically, having one axial discontinuity centered on the equatorial plane of the tire makes it possible to reduce the tensions in the reinforcing elements of the working reinforcement at the shoulders by increasing the tensions in the reinforcing elements of the working reinforcement at the centre.

Advantageously, two axial discontinuities are positioned symmetrically with respect to the equatorial plane. In such an embodiment, the vibrational phenomena of the rotating tire are optimized.

According to one particular embodiment, the hoop reinforcement comprises two hooping layers. Depending on the pressure necessary for supporting the load, in accordance with its use, an aeroplane tire may require a hoop reinforcement made up of two hooping layers.

According to a preferred embodiment, the reinforcing elements of a hooping layer consist of aliphatic polyamides, aromatic polyamides or a combination of aliphatic polyamides and aromatic polyamides. Such reinforcing elements are particularly advantageous on account of their low weight and their breaking strength. In other words, the material of which the reinforcing elements of a hooping layer are made is generally nylon or aramid. The reinforcing elements may consist of a single material or a combination of different materials. For example, they may combine spun nylon and aramid filaments so as to form what are referred to as hybrid reinforcing elements. These hybrid reinforcing elements advantageously combine the extension properties of nylon and of aramid. This type of material is advantageously used in the field of aeroplane tires because of their low density, allowing weight savings that are crucial in the aeronautical field.

It is particularly advantageous, in order to take up tensions in the working reinforcement, to dispose the reinforcing elements of this reinforcement in a manner parallel to one another and inclined, with respect to the circumferential direction (XX′), at an angle of between +20° and −20°.

It is also advantageous for the reinforcing elements of a working layer to consist of aliphatic polyamides, aromatic polyamides or a combination of aliphatic polyamides and aromatic polyamides, on account of their low weight and their level of breaking strength. Here too, the material of which the reinforcing elements of a working layer are made is nylon, aramid or hybrid. These are commonplace materials in the field of aeroplane tires since they have the advantage of lightness of weight.

According to a preferred embodiment, the carcass reinforcement comprises at least one carcass layer comprising mutually parallel reinforcing elements that form an angle of between 80° and 100° with the circumferential direction. The reinforcing elements of a carcass layer consist of aliphatic polyamides, aromatic polyamides or a combination of aliphatic polyamides and aromatic polyamides. Here too, it is particularly advantageous to use such reinforcing elements on account of their low weight and their breaking strength.

Preferably, a protective reinforcement comprising at least one protective layer made up of metal or textile reinforcing elements is disposed radially on the outside of the working reinforcement in order to preserve the mechanical integrity of the working layers in the case that an obstacle is rolled over.

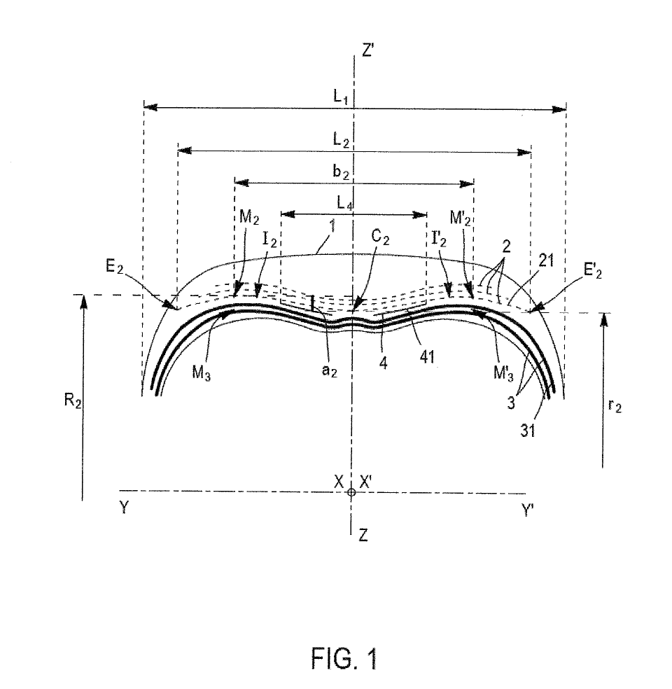

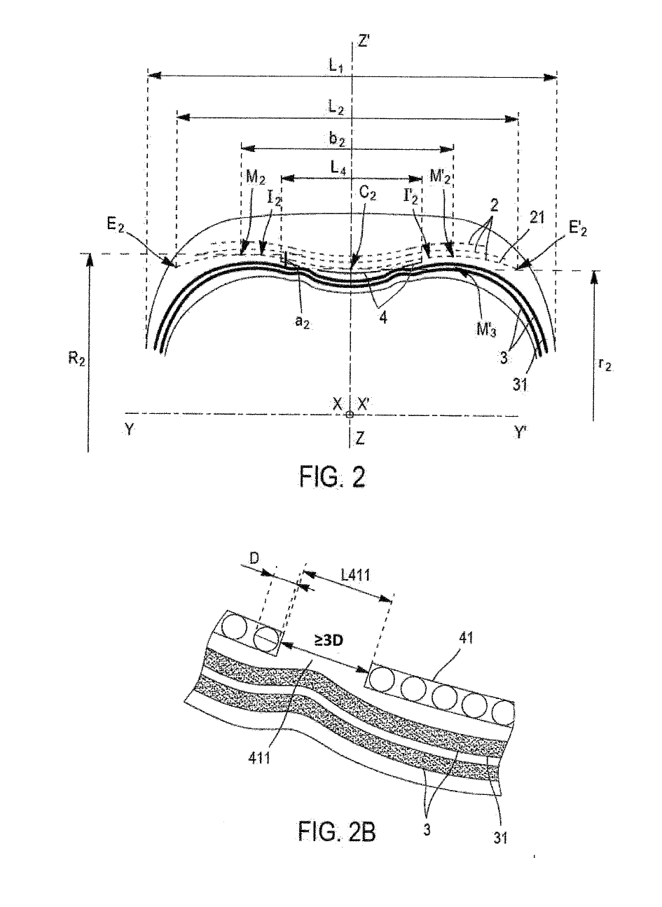

The features and other advantages of the invention will be understood better with the aid of FIGS. 1 and 2, said figures not being shown to scale but in a simplified manner so as to make it easier to understand the invention.

FIG. 1: hooping layer having 1 axial discontinuity in the hoop reinforcement centered on the equatorial plane

FIG. 2: hooping layer having 2 symmetrical axial discontinuities in the hoop reinforcement with respect to the equatorial plane

FIG. 2B: detail of an axial discontinuity in the hoop reinforcement

FIG. 1 shows a meridian section, i.e. a section in a meridian plane, of the crown of a tire according to a first embodiment of the invention comprising a tread 1, a working reinforcement 2 radially on the inside of the tread 1, a radial carcass reinforcement 3 radially on the inside of the working reinforcement 2 and a hoop reinforcement 4 positioned radially between the working reinforcement 2 and the radial carcass reinforcement 3, said hoop reinforcement 4 comprising a hooping layer 41 comprising an axial discontinuity in the equatorial plane XZ.

The respective radial, axial and circumferential directions are the directions ZZ′, YY′ and XX′. The equatorial plane XZ is defined by the radial direction ZZ′ and the circumferential direction XX′.

The working reinforcement 2 is made up of several working layers. The axial width L2 of the radially internal working layer 21, which is the axial distance between its axial ends E2 and E′2, is at least equal to two-thirds of the maximum axial width L1 of the tire. The maximum axial width L1 of the tire is measured at the sidewalls, with the tire mounted on its rim and lightly inflated, i.e. inflated to a pressure equal to 10% of its recommended nominal pressure.

The radially internal working layer 21 comprises a concave portion, the axial limits M2 and M′2 of which, on either side of the equatorial plane XZ, are the radially external points of said working layer, positioned at the radial distance R2. The radially internal working layer 21 further comprises two convex portions axially on the outside of said concave portion. These convex portions are respectively bounded axially on the inside by the axial limits M2 and M′2 of the concave portion and axially on the outside by the ends E2 and E′2 of the working layer.

The concave portion of the radially internal working layer 21 comprises a part that is concave in the mathematical sense, axially delimited by the points of inflection I2 and I′2, and, on either side of said concave part, a part that is convex in the mathematical sense, axially bounded on the outside by an axial limit M2 or M′2 of said concave portion. The amplitude of concavity a2 is the difference between the radial distance R2 of the axial limits M2 and M′2 and the radial distance r2 of the point C2 situated in the equatorial plane XZ.

The carcass reinforcement 3 is made up of several carcass layers. In the crown region, radially on the inside of the working reinforcement 2, the radially external carcass layer 31 comprises a portion of which the axial limits M3 and M′3, on either side of the equatorial plane, are radially in line with the radially external points of the radially innermost (M2, M′2) working layer, in which portion the carcass layer is on either side of the equatorial plane radially on the inside of its respective ends (M3, M′3) positioned at the radial distance R3, give or take manufacturing spread.

Moreover, FIG. 1 shows a hoop reinforcement 4 comprising a hooping layer 41 that is positioned radially between the radially internal working layer 21 and the radially external carcass layer 31 and having an axial discontinuity 411 centered on the equatorial plane XZ.

FIG. 2 shows a meridian section through the crown of a tire according to a second embodiment of the invention, wherein the hoop reinforcement comprises a hooping layer 41 comprising 2 axial discontinuities which are symmetrical with respect to the equatorial plane XZ and have the same axial width. The other elements of the architecture of FIG. 2 are identical to those in FIG. 1.

FIG. 2B shows the hooping layer 41 made up of reinforcing elements having a mean diameter D, said figure showing a discontinuity 411 of width L411, said width, according to the invention, being greater than 3 times the mean diameter D.

The inventors have carried out the invention according to the two embodiments, with a hoop reinforcement comprising two axial discontinuities that are symmetrical with respect to the equatorial plane, for an aeroplane tire of size 46×17R20, the use of which is characterized by a nominal pressure of 15.9 bar, a nominal static load of 20473 daN and a maximum reference speed of 225 km/h.

In the tires studied, the working reinforcement is made up of 6 working layers, the reinforcing elements of which are of the hybrid type. The radially internal working layer has an axial width of 300 mm, i.e. 0.75 times the maximum axial width of the tire. The width of concavity of said radially internal working layer is 160 mm and the amplitude of concavity is 6 mm. The carcass reinforcement is made up of 3 carcass layers, the reinforcing elements of which are hybrid.

The hoop reinforcement is made up of a hooping layer, the reinforcing elements of which are of the hybrid type with a mean diameter of 1.11 mm. The axial width of the hoop reinforcement is 80 mm, i.e. 0.20 times the maximum axial width of the tire. For the working and hooping layers, the hybrid reinforcing elements used consist of two spun aramid yarns of 330 tex each and one spun nylon yarn of 188 tex. The diameter of the hybrid reinforcing element obtained is 1.11 mm, its titre is 950 tex, its twist is 230 tpm, its elongation under 50 daN of force is 5.5% and its breaking force is 110 daN.

For the carcass layers, the hybrid reinforcing elements used consist of two spun aramid yarns of 330 tex each and one spun nylon yarn of 188 tex. The diameter of the hybrid reinforcing element obtained is 1.1 mm, its titre is 980 tex, its twist is 270 tpm, its elongation under 50 daN of force is 5.5% and its breaking force is 110 daN. Further hybrid reinforcements could also be used. It is notably conceivable to use reinforcements with a different twist, or even reinforcements having a different titre or a different number of each spun yarn.

The change from a flat profile to a concave profile of the working layer as described in the patent WO2013079351A1 causes a significant increase in the tension in the reinforcing elements at the centre of the working layers of around +15%, with the same stack of reinforcing elements of the crown layers and with the same mean radius of the radially external meridian profile of the tread.

Increasing the axial width of the hooping layer by 50 mm, changing its axial width from 80 mm to 130 mm, makes it possible to reduce excess tension by around 20% at the centre of the working reinforcement layers and by around 18% at the edge of the working reinforcement, but with the cost of the hooping reinforcing elements being increased by 65%. The use of a discontinuous hooping layer with an overall axial width of 130 mm, comprising a middle portion with an axial width of 80 mm and two lateral portions that are symmetrical with respect to the equatorial plane and have respective axial widths of 10 mm, each lateral portion being separated from the middle portion by a discontinuity having an axial width of 20 mm, makes it possible to reduce excess tension at the centre of the working layers by around 6% and at the edge of the working reinforcement by around 26%, with the increase in the cost of the hooping reinforcing elements also being limited to 25%.

The more the hooping layer is widened with respect to the equatorial plane by the introduction of discontinuities, the more the effect on the tension in the reinforcing elements at the end of the working reinforcement is favourable. The optimum position of the discontinuities in the hooping layer depends on the disposition and the width of the working layers.

The use of reinforcing elements for the hooping layer of different nature, made of aramid for example, makes it possible, in the same configuration as before, to reduce the excess tension at the centre of the working layers by around 36% and at the edge of the working reinforcement by around 49%.

For a hoop reinforcement made of aramid, one of the preferred variants is realized by using strips of 5 to 10 reinforcing elements laid over an overall width of 130 mm, in 6 portions that are distributed symmetrically with respect to the equatorial plane, these 6 portions being separated by discontinuities having axial widths of between 10 and 20 mm. The use of aramid and not of hybrid for the hoop reinforcement associated with this disposition makes it possible to reduce excess tension at the centre of the working layers by around 25% and at the edge of the working reinforcement by around 15%, achieving the level of excess tension close to that of the solution having a discontinuous hybrid hooping layer as described above, and thus meeting endurance criteria while reducing the cost of the hooping layer by 30% compared with that solution.

1. A tire for an aeroplane, comprising:
a tread;
a working reinforcement radially on the inside of the tread and comprising at least one working layer;
the radially internal working layer having an axial width at least equal to two-thirds of the maximum axial width of the tire and comprising a concave portion;
a carcass reinforcement radially on the inside of the working reinforcement and comprising at least one carcass layer;
a hoop reinforcement radially on the outside of the carcass reinforcement and comprising at least one hooping layer;
the hooping layer having an axial width at most equal to 0.8 times the width of the widest working layer and comprising mutually parallel reinforcing elements that are inclined, with respect to the circumferential direction, at an angle of between +10° and −10°; and
the reinforcing elements of the hooping layer having a mean diameter D,
wherein the hooping layer comprises at least one axial discontinuity having an axial width at least equal to three times the mean diameter D of the reinforcing elements.

2. The aeroplane tire according to claim 1, wherein the axial width of the axial discontinuity is at least equal to 10 times the mean diameter D of the reinforcing elements of the hooping layer.

3. The aeroplane tire according to claim 1, wherein the hooping layer comprises at least two axial discontinuities having axial widths at least equal to three times the mean diameter D of the reinforcing elements of the hooping layer.

4. The aeroplane tire according to claim 1, wherein one said axial discontinuity is centered on the equatorial plane of the tire.

5. The aeroplane tire according to claim 3, wherein two said axial discontinuities are positioned symmetrically with respect to the equatorial plane.

6. The aeroplane tire according to claim 1, wherein the hoop reinforcement comprises two said hooping layers.

7. The aeroplane tire according to claim 1, wherein the reinforcing elements of a said hooping layer consist of aliphatic polyamides, aromatic polyamides or a combination of aliphatic polyamides and aromatic polyamides.

8. The aeroplane tire according to claim 1, wherein a said working layer comprises mutually parallel reinforcing elements that are inclined, with respect to the circumferential direction, at an angle of between +20° and −20°.

9. The aeroplane tire according to claim 1, wherein wherein the reinforcing elements of a said working layer consist of aliphatic polyamides, aromatic polyamides or a combination of aliphatic polyamides and aromatic polyamides.

10. The aeroplane tire according to claim 1, comprising at least one said carcass layer comprising mutually parallel reinforcing elements that form an angle of between 80° and 100° with the circumferential direction, wherein the reinforcing elements of a carcass layer consist of aliphatic polyamides, aromatic polyamides or a combination of aliphatic polyamides and aromatic polyamides.

11. The aeroplane tire according to claim 1, wherein a protective reinforcement comprising at least one protective layer made up of metal or textile reinforcing elements is disposed radially on the outside of the working reinforcement.
